(19) United States
(12) Patent Application Publication
(10) Pub. No.: US 2020/0169541 A1
(43) Pub. Date: May 28, 2020

(54) SYSTEMS AND METHODS FOR ENCRYPTION

(71) Applicant: David Stein, Mercer Island, WA (US)

(72) Inventor: David Stein, Mercer Island, WA (US)

(21) Appl. No.: 16/199,661

(22) Filed: Nov. 26, 2018

(51) Int. Cl. H04L 29/06; H04L 9/06; H04L 9/08

(52) U.S. Cl. CPC H04L 63/0435; H04L 9/0618; G06F 7/588; H04L 9/0819; H04L 9/0869

(57) ABSTRACT

Pursuant to some embodiments, systems, methods, apparatus and computer program code for encrypting and decrypting a message are provided.

### RELATED APPLICATIONS

This application is based on, and claims benefit of and priority to, U.S. Provisional Patent Application Ser. No. 62/749,599 filed on Oct. 23, 2018.

### FIELD

The present invention relates to systems and methods for encryption.

### BACKGROUND

Encryption is used in a wide range of applications, from wireless telephones to local area networks to over the top communication applications. Any environment where users or businesses wish to maintain confidentiality of data may benefit from the use of encryption systems and methods.

The effectiveness of an encryption system partly depends upon the complexity of the encryption method employed. Generally, simple encryption methods are prone to hacking or unauthorized access to data. As a result, encryption systems have become highly complex, requiring substantial computing power and resources. It would be desirable to provide a secure encryption system and method which is relatively easy to implement with minimal computing power and resources.

### BRIEF DESCRIPTION OF THE DRAWINGS

FIG. 1 is a block diagram of a system according to some embodiments.

FIG. 2 is a flow diagram depicting a process to generate and transmit an encrypted message pursuant to some embodiments.

FIG. 3 is a flow diagram depicting a process to encrypt a message pursuant to some embodiments.

FIG. 4 is a flow diagram depicting a decryption process pursuant to some embodiments.

### DESCRIPTION

Pursuant to some embodiments, systems, methods, apparatus and computer program code for encrypting and decrypting a message are provided. Pursuant to some embodiments, an encryption system, method, apparatus or computer program code for encrypting a message pursuant to the present invention may include receiving, at a sender device, a message to be encrypted and a secret key, performing a cipher process, the cipher process including taking at least a portion of the message as a key to a cipher lookup table such that the value that the key maps to is an output of the cipher process, performing a scramble process, the scramble process operating on the output of the cipher process and scrambling the values at keys associated with values from a random number generator to generate an encrypted message, and transmitting the encrypted message to a recipient.

In some embodiments, the cipher process may be performed any number of times (even zero times).

Pursuant to some embodiments, a decryption system, method, apparatus or computer program code for encrypting a message pursuant to the present invention may include receiving, at a recipient device, the encrypted message, performing an unscramble process, the unscramble process operating on a lookup table having a scramble length and a scramble block size, the lookup table having a set of keys and values, the unscramble process unscrambling the values at keys associated with values from a random number generator to create an unscramble table, performing a decipher process, the decipher process including regenerating the cipher table and inverting the cipher table to create a decipher table, and applying the decipher table to the unscramble table to produce the message. Pursuant to some embodiments, the decipher processing may be performed any number of times (including zero) and should be performed a corresponding number of times as the cipher process.

Pursuant to embodiments of the present invention, the encryption and decryption processing is performed with very little computational overhead or resources, allowing the encryption and decryption of messages or other data in a wide range of environments and without specialized hardware.

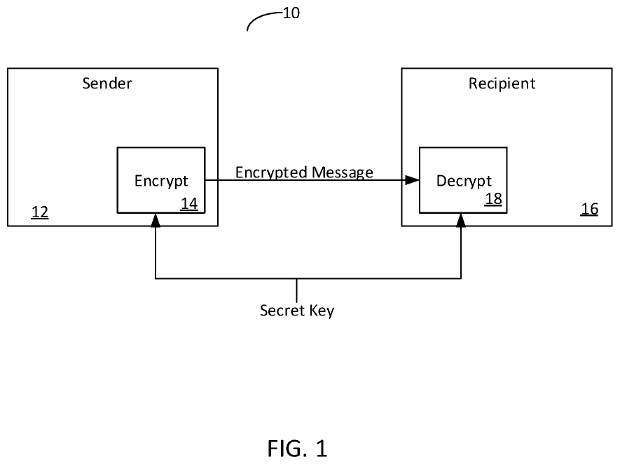

FIG. 1 is block diagram of a system 10 according to some embodiments of the present invention. As shown, a sender operating a sender device 12 wishes to send a secure message to a recipient operating a recipient device 16. The sender device 12 and recipient device 16 may be, for example, computing devices (e.g., such as mobile telephones or the like) equipped with software allowing the devices to operate pursuant to the present invention. For example, the sender device 12 may include code that allows the message to be encrypted as described herein. The recipient device 16 may include code that allows the received message to be decrypted as described herein. Pursuant to some embodiments, the sender device 12 and the recipient device 16 share a secret key (which may be, for example, selected or generated by the sender for use in a communication and provided to the recipient). In some embodiments, the sender device 12 and the recipient device 16 are each equipped with software and functionality to both encrypt and decrypt (e.g., the sender device 12 may act as both a sender and a recipient, as may the recipient device 16). In some embodiments, the software or functionality allowing for the encryption and the decryption may be provided by a service accessible to either or both of the sender device 12 and the recipient device 16 (e.g., the encryption and decryption functionality may be provided as a hosted service or as part of a network resource or the like).

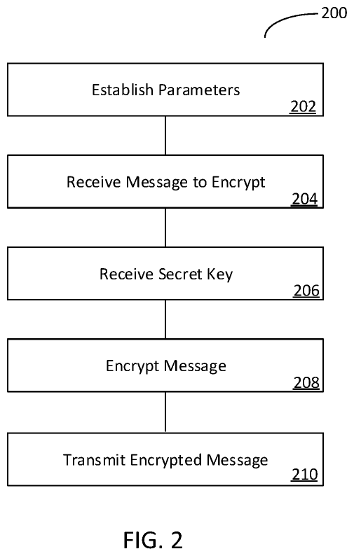

Reference is now made to FIG. 2 where a process 200 to generate and transmit an encrypted message is shown (e.g., where the encrypted message is generated by or on behalf of a sender operating or associated with a sender device 12 for transmission to a recipient operating or associated with a recipient device 16). The process 200 may be performed in a module or component associated with a device 12 operated by or on behalf of a sender (e.g., such as the encryption module 14).

The process 200 may start with establishing one or more parameters to perform the encryption at 202. In some embodiments, a number of encryption parameters may be required to be established to perform the encryption. For example, as will be described further below, the following parameters may be required: a cipher block size, a scramble block size, and a scramble length. In some embodiments, each of these parameters may be measured in bits. Further, in some embodiments, some or all of these parameters may be pre-configured. For example, an encryption module 14 may be configured to always operate with a pre-determined cipher block size, a pre-determined scramble block size and a pre-determined scramble length. In other embodiments, some or all of these parameters may be configured based on the length of the message to be encrypted or based on other attributes of the message or transmission. Further details of each of these parameters, and how they are used in conjunction with the present invention, will be described further below.

Processing continues at 204 where the message to encrypt is received or selected. The message may be received or selected in a number of different ways. For example, the message may be received via a keypad associated with a device 12 operated by the sender. The message may also be selected using a software application associated with a device 12 operated by the sender (e.g., the device 12 may include an email software application which allows the sender to select to encrypt one or more email messages or portions thereof using the present invention).

After the message is received or selected, processing may continue at 206 where a secret key is received. In general, the secret key can be any password, passphrase, or other piece of data. The secret key is received by a sender device (where “received” means that the secret key is entered or otherwise provided or made available to the encryption software 14 of the sender device 12). As will be further discussed below, in some situations the secret key may be received in a form that is not directly usable by a random number generator, so the secret key may be hashed into a numerical format that is usable as a seed to a random number generator.

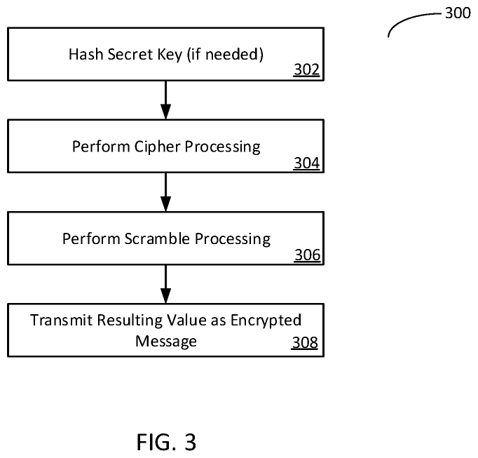

Processing continues at 208 where the message is encrypted. A number of process steps occur to perform the encryption (and such steps are described in further detail in conjunction with FIG. 3, below). Once the message is encrypted, it can be transmitted at 210 to a recipient (or recipients). The encrypted message may be transmitted in any of a number of ways known in the art.

Referring now to FIG. 3, where a flow diagram is shown depicting a process 300 to encrypt a message pursuant to some embodiments. The process 300 generally corresponds to the processing performed at block 208 of FIG. 2. In some embodiments, the process 300 is performed by, for example, an encryption module 14 associated with a device 12 operated by or on behalf of a sender who wishes to encrypt a message prior to transmission of the message to one or more recipients.

The encryption process 300 begins at 302 where the secret key (which was received or identified at 206 of FIG. 2) is hashed if needed. In some situations, the secret key may be received in a form that is not directly usable by a random number generator, so the secret key may be hashed into a numerical format that is usable as a seed to a random number generator. Processing continues at 304 where cipher processing is performed. Prior to describing details of cipher processing pursuant to some embodiments it is important to note that the processing of 304 and 306 may be performed in a different order (e.g., the scramble processing 306 may be performed before the cipher processing 304) so long as the corresponding steps are reversed in the decryption process 400 described further below. Further, in some embodiments, the number of cipher processes performed is zero—that is, embodiments, in some scenarios, may be performed without cipher processing.

Returning to the description of the cipher processing 304, the processing begins with the creation of an initial cipher table. The initial cipher table created at 304 may simply be a table of key value pairs having a number of pairs equal to 2\hat{ }[number of bits in the cipher block size]. For example, if the cipher block size is 4, the table created at 304 will have 16 key value pairs. If the cipher block size is 1 byte (8 bits), then the cipher table must have a size of 2\hat{ }8, or 256. Each element of the cipher table is then filled with a mapping where the key is the index in the cipher table, and the value is also the index to the lookup table, with the first index being 0. This is to ensure that each key is mapped to a unique integer value in the range [0, lookup table size]. In general, the cipher block size should be selected to be greater than one bit. A single byte should be sufficient, but excessively small cipher blocks are less secure. For example, a cipher of a single bit will either simply invert all of the data or leave it unchanged.

The cipher table is shuffled by first operating the random number generator to generate one or more random numbers. The random number generator can be any of a variety of random number generators, although it is recommended that cryptographically secure generators are used. The hashed password (or the actual password in the case of a purely numeric password) is then used as a seed for the random number generator.

The cipher table is shuffled based on the output of the random number generator. This is the start of a shuffling process where the values in the cipher table are shuffled. A number of indexes greater than 1 (2 should be sufficient) are chosen from the cipher table using the random number generator and swapped with each other. The swap operation continues until the table is shuffled. This swap operation is performed a number of times, with more swaps producing a higher quality cipher table. In general, the number of swaps should be at least equal to the size of the cipher table, but a number of swaps much larger than that may be excessive and produce no significant increase in quality of the cipher table. The number of swaps can be randomly generated or taken as an input (e.g., at 202 of FIG. 2 or elsewhere). Cipher processes can share cipher tables, so the number of cipher tables generated does not need to equal the number of cipher processes. The cipher tables must be set up before the scramble and cipher processes run so that during decryption, the cipher tables can also be generated, and the random number generator can be in the correct state to perform the unscramble process.

Processing continues with a shuffle or scramble process 306. During the scramble process, a scramble block size and a scramble length that is a multiple of the scramble block size is chosen, this can also be taken as input to the process. A piece of the input equal in size to the scramble length is taken. This piece of the input is the scramble block. Some numbers (at least 2) in the range [0, scramble length/scramble block size] are chosen. These are used as indexes to the scramble block, where each element at an index is equal in size to the scramble block size. The pieces of data of length scramble block size at those indexes into the scramble block are then swapped. This swap operation is performed a number of times, that number can be randomly generated or taken as input. After those swap operations are completed, the scramble block is added to the output, and a new scramble block is taken from the input while there is input remaining. Once all of the data has been scrambled, the output of this process is used as input to the next process, including the random number generator.

The input data is now ciphered. During this process, a piece of data of length equal to the cipher block size is taken from the input to the process, and then the value of that piece of data is used as a key to the cipher lookup table for that cipher process. The value that that key maps to is taken to be the output, which is added to the processes output. This is repeated until all the input data has passed through the process once. This output is used as input to the next process, and the random number generator, having had its state changed, is passed through as well.

When all processes are completed, the output is the output encrypted data. The output may be transmitted to the recipient at 320 as shown in FIG. 1.

The cipher process and scramble process can be performed in any order, and the cipher process can be performed any number of times (including in some embodiments, zero times), however a single run of each process is normally sufficient. Importantly, during the decryption process, the unscramble and decipher processes must be run in reverse order of the scramble and cipher processes during the encryption process.

Prior to a discussion of the decryption process, an illustrative but not limiting example of the encryption process described above and shown in conjunction with FIG. 3 will now be provided. In the illustrative example, a first party operating a sender device 12 wishes to encrypt a message for transmission to a second party operating a recipient device 16. The first party selects a secret key (or password) of “password” and provides it to the encryption software 14 at step 202. The encryption software 14 associated with the first party is configured (at least for this message) to use a cipher block size of four (4) bits, a scramble block size of four (4) bits, a scramble length of twenty-four (24) bits. The message to be encrypted and transmitted has twenty-four (24) bits of data.

Because the secret key is an alphanumeric string, processing at 302 is performed to hash the secret key. For the purposes of illustration, the secret key is hashed into a numerical format of 1216985755. This numeric is provided as an input to seed the random number generator (e.g., during cipher processing and scramble processing at 304 and 306). As discussed above, either cipher processing 304 or scramble processing 306 may be performed first (so long as the reverse sequence is performed during decryption processing). In the illustrative example, cipher processing is performed first.

In the illustrative example, an initial cipher table is created as shown in Table I, below:

TABLE I

| Key | Value |
|---|---|
| 0 | 0 |
| 1 | 1 |
| 2 | 2 |
| 3 | 3 |
| 4 | 4 |
| 5 | 5 |
| 6 | 6 |
| 7 | 7 |
| . . . | . . . |
| 13 | 13 |
| 14 | 14 |
| 15 | 15 |

The cipher processing in the illustrative example continues by operating the random number generator (using the numeric value of the secret key as a seed) to generate two random numbers. These random numbers are used to perform a swap of values in the cipher table. In the illustrative example, operation of the random number generator result in the following random numbers: 2, 7. The encryption module 14 is operated to perform a swap of the values at 2 and 7, resulting in an intermediate version of the cipher table that looks (in part) like the table shown as Table II (where one swap operation has been performed resulting in the swap of the values for keys 2 and 7).

TABLE II

| Key | Value |
|---|---|
| 0 | 0 |
| 1 | 1 |
| 2 | 7 |
| 3 | 3 |
| 4 | 4 |
| 5 | 5 |
| 6 | 6 |
| 7 | 2 |
| . . . | . . . |

The encryption module 14 continues to process the shuffling of the cipher table by generating further random number pairs and continuing to shuffle the table until all keys of the table have been shuffled. The resulting cipher table in the illustrative example is shown as Table III.

TABLE III

| Key | Value |
|---|---|
| 0 | 8 |
| 1 | 14 |
| 2 | 7 |
| 3 | 6 |
| 4 | 1 |
| 5 | 12 |
| 6 | 9 |
| 7 | 2 |
| . . . | . . . |

The data to be encrypted (e.g., the unencrypted message or data received at 204) is now used as the key to the shuffled cipher table. In the illustrative example, the unencrypted message to be encrypted is 3, 1, 5, 7, 2, 0 (put another way, the value of “3” is at position “0”, the value of “1” is at position “1”, etc.). By using the value of the input data as the key to the shuffled cipher table, the following table results:

TABLE IV

| Key | Value |
|---|---|
| 0 | 6 |
| 1 | 14 |
| 2 | 12 |
| 3 | 13 |
| 4 | 7 |
| 5 | 8 |

Now, the resulting is scrambled (e.g., during scramble processing at 306). The scramble process of the illustrative example occurs as follows. The numeric version of the secret key is used as a seed to the random number generator, and two random numbers are generated. As an illustrative example, the first two random numbers generated are 2,4. An intermediate scrambled table is generated as shown below as Table V (where the values at keys 2 and 4 have been swapped):

TABLE V

| Key | Value |
|---|---|
| 0 | 6 |
| 1 | 14 |
| 2 | 7 |
| 3 | 13 |
| 4 | 12 |
| 5 | 8 |

The scrambling continues until all rows of the table have been scrambled to produce the encrypted message for transmission. For example, in the illustrative example, the output message may be 8, 13, 6, 7, 14, 12.

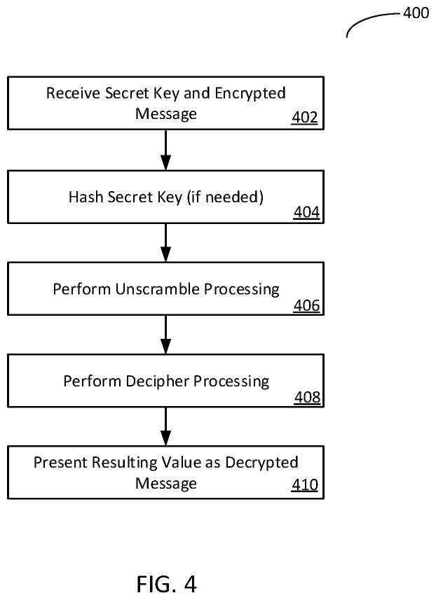

Reference is now made to FIG. 4 where a decryption process pursuant to some embodiments will now be described.

To decrypt the data, a process is followed which is generally the inverse of the process to encrypt the data. For example, if the encryption process performed cipher processing 304 and then scramble processing 306, the decryption process will perform (un)scramble processing 406 and then (de)cipher processing 408. The scramble processing 406 and the (de)cipher processing 408 are generally similar to the processes performed during encryption except as noted below. Further, to decrypt the data, an additional step is needed in which the cipher tables are inverted to create the decipher tables. This is done because each key in the cipher table points to a unique value, to create the decipher tables all you need to do is create a new lookup table for each cipher table, and for each key-value pair in the cipher tables, add the inverse pair to the decipher table, where the value in the cipher table is the key in the decipher table, and the key in cipher table is the value in the decipher table. The decipher steps and unscramble step are then performed in the reverse order as the cipher and scramble steps were performed during the encryption.

The decipher processing 408 is the same as the cipher processing 304, but instead of using a cipher table, it uses the corresponding decipher table. The encryption and decryption process should use a corresponding number of cipher and decipher processes (for example, if the encryption process used zero cipher processes, the decryption process should use zero decipher processes). Each piece of ciphered input of the cipher block size is taken and used as a key to the decipher table. The value that is mapped to by that key is then added to the output.

The unscramble processing 406 is a little different. For each scramble block, create a lookup table with size scramble length/scramble block size. Fill each entry with a key value pair where the key and value are both the index of the pair. Then perform the scramble processing 406 the same way as in the encryption on the lookup table. Next, as in the creation of the decipher table, the lookup table must be inverted, where for each key-value pair, the value becomes the key and the key becomes the value. This will give a new lookup table, where a key is the scrambled position of the piece of data in the scramble block, and the value is the unscrambled position. Using this lookup table, each piece of data of scramble block size, is placed into the correct location on the output block, which is then added to this process's final output. This step is then performed for each scramble block in the input. The output of this step is used the input for the next step in the process.

The final output is the unencrypted data which may be presented as the decrypted message data at 410.

If the same seed to random number generator, and therefore the same secret key is used in process 400 as was used to encrypt the data in process 300, the random number generator will output the same sequence of numbers, and calculate the same cipher tables and scramble the lookup tables the same way as during encryption 300, and the output of the decryption process 400 therefore will be the same as the input to the encryption (e.g., at 204).

Just as was provided for the encryption process, an illustrative example of the decryption process will now be provided. The example follows the encryption example presented above and starts with the receipt of the encrypted message of 8, 13, 6, 7, 14, 12. The decryption software or module 18 associated with the recipient device 16 is operated to perform the decryption process, and is provided with the same secret key as was provided to the encryption module 14 (where the secret key is the word “password”). The parameters used by the encryption module 14 are also used by the decryption module 18 (e.g., the cipher block size is set to 4 bits, the scramble block size is 4 bits, the scramble length is 24 bits, and there are 24 bits of message data).

Once again, since the secret key is provided as a string (where the secret key is “password”), and it is first hashed to produce a numeric value of 1216985755. The hashed secret key is provided to the random number generator as a seed to generate a cipher table (similar to the way the cipher table was originally generated in the encryption example above). By using the same random number values as well as the same swap or shuffling process, the following cipher table (Table VI) is created by the decryption module 18 (which is identical to Table III discussed above):

TABLE VI

| Key | Value |
|---|---|
| 0 | 8 |
| 1 | 14 |
| 2 | 7 |
| 3 | 6 |
| 4 | 1 |
| 5 | 12 |
| 6 | 9 |
| 7 | 2 |
| . . . | . . . |

The cipher table (as shown in Table VI) is then inverted to create Table VII shown below:

TABLE VII

| Key | Value |
|---|---|
| 8 | 0 |
| 14 | 1 |
| 7 | 2 |
| 6 | 3 |
| 1 | 4 |
| 12 | 5 |
| 9 | 6 |
| 2 | 7 |
| . . . | . . . |

Next, the decryption module 18 is operated to create an unscramble table. The unscramble table may be started with the table shown below as Table VIII.

TABLE VIII

| Key | Value |
|---|---|
| 0 | 0 |
| 1 | 1 |
| 2 | 2 |
| 3 | 3 |
| 4 | 4 |
| 5 | 5 |

The values in the unscramble table are then scrambled (using a similar process as was used by in the encryption stage, where the hashed secret key is input to the random number generator as a seed and the output random numbers are used in a shuffling process). The resulting unscramble table may appear as shown below in Table IX:

TABLE IX

| Key | Value |
|---|---|
| 0 | 5 |
| 1 | 3 |
| 2 | 0 |
| 3 | 4 |
| 4 | 1 |
| 5 | 2 |

The unscramble table is then used to convert the input encrypted message data into its original position (the position it was in during the encryption process before it was scrambled). This is done by putting the encrypted data values into the positions identified by the unscramble table. For example, the input data value at position “0” (or key “0”) is “8”. As shown in Table IX, the unscramble table tells us to place the input data value at position “0” into position “5”. This is repeated for each input data value of the encrypted message. The result in the illustrative example is shown below in Table X.

TABLE X

| Key | Value |
|---|---|
| 0 | 6 |
| 1 | 14 |
| 2 | 12 |
| 3 | 13 |
| 4 | 7 |
| 5 | 8 |

Processing continues as the unscrambled encrypted message is now deciphered. This is performed by using the inverted cipher table of Table VII which tells the decipher process to replace values. For example, the unscrambled encrypted message of 6 14 12 13 7 8 is deciphered by replacing the “6” with “3”, the “14” with “1” and so on until the decrypted message is revealed to be: 3 1 5 7 2 0.

Any of the devices described herein might be associated with, for example, a Personal Computer (PC), a laptop computer, a smartphone, an enterprise server, a server farm, and/or a database or similar storage devices.

As used herein, devices, including those associated with the sender or the recipient and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Note that the encryption and decryption software or modules may be locally stored (and/or hosted) or reside remote from the sender or recipient devices. Although a single transaction is shown in FIG. 1, any number of such interactions may be supported. Moreover, various devices described herein might be combined according to embodiments of the present invention. All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

I claim:

1. A computerized method to process a message, comprising:
receiving, at a sender device, a message to be encrypted and a secret key;
performing a cipher process, the cipher process including taking at least a portion of the message as a key to a cipher lookup table such that the value that the key maps to is an output of the cipher process;
performing a scramble process, the scramble process operating on the output of the cipher process and scrambling the values at keys associated with values from a random number generator to generate an encrypted message; and
transmitting the encrypted message to a recipient.

2. The computerized method of claim 1, further comprising:
prior to performing the cipher process, establishing a cipher block size.

3. The computerized method of claim 1, further comprising:
prior to performing the scramble process, establishing a scramble block size and a scramble length.

4. The computerized method of claim 1, further comprising:
hashing the secret key to produce a numeric;
providing the hashed secret key as a seed to the random number generator.

5. The computerized method of claim 1, further comprising:
repeating the cipher process more than one time to generate the output of the cipher process.

6. The computerized method of claim 1, further comprising:
providing the secret key to the recipient for use in decrypting the encrypted message.

7. The computerized method of claim 2, further comprising:
providing the cipher block size to the recipient for use in decrypting the encrypted message.

8. The computerized method of claim 3, further comprising:
providing the scramble block size and the scramble length to the recipient for use in decrypting the encrypted message.

9. The computerized method of claim 1, further comprising:
receiving, at a recipient device, the encrypted message;
performing an unscramble process, the unscramble process operating on a lookup table having a scramble length and a scramble block size, the lookup table having a set of keys and values, the unscramble process unscrambling the values at keys associated with values from a random number generator to create an unscramble table;
performing a decipher process, the decipher process including regenerating the cipher table and inverting the cipher table to create a decipher table; and
applying the decipher table to the unscramble table to produce the message.

10. The computerized method of claim 9, further comprising:
receiving information identifying the order in which the encrypted message was generated.

11. A non-transitory computer-readable storage medium having stored therein instructions that when executed cause a computer to perform a method to process a message, the method comprising:
receiving, at a sender device, a message to be encrypted and a secret key;
performing a cipher process, the cipher process including taking at least a portion of the message as a key to a cipher lookup table such that the value that the key maps to is an output of the cipher process;
performing a scramble process, the scramble process operating on the output of the cipher process and scrambling the values at keys associated with values from a random number generator to generate an encrypted message; and
transmitting the encrypted message to a recipient.

12. The non-transitory computer-readable medium of claim 11, further comprising:
prior to performing the cipher process, establishing a cipher block size.

13. The non-transitory computer-readable medium of claim 11, further comprising:
prior to performing the scramble process, establishing a scramble block size and a scramble length.

14. The non-transitory computer-readable medium of claim 11, further comprising:
hashing the secret key to produce a numeric;
providing the hashed secret key as a seed to the random number generator.

15. The non-transitory computer-readable medium of claim 11, further comprising:
repeating the cipher process more than one time to generate the output of the cipher process.

16. The non-transitory computer-readable medium of claim 11, further comprising:
providing the secret key to the recipient for use in decrypting the encrypted message.

17. The non-transitory computer-readable medium of claim 12, further comprising:
providing the cipher block size to the recipient for use in decrypting the encrypted message.

18. The non-transitory computer-readable medium of claim 13, further comprising:
providing the scramble block size and the scramble length to the recipient for use in decrypting the encrypted message.

19. The non-transitory computer-readable medium of claim 11, further comprising:
receiving, at a recipient device, the encrypted message;
performing an unscramble process, the unscramble process operating on a lookup table having a scramble length and a scramble block size, the lookup table having a set of keys and values, the unscramble process unscrambling the values at keys associated with values from a random number generator to create an unscramble table;
performing a decipher process, the decipher process including regenerating the cipher table and inverting the cipher table to create a decipher table; and
applying the decipher table to the unscramble table to produce the message.

20. The non-transitory computer-readable medium of claim 19, further comprising:
receiving information identifying the order in which the encrypted message was generated.
